(19) United States
(12) Patent Application Publication
(10) Pub. No.: US 2009/0166912 A1
(43) Pub. Date: Jul. 2, 2009

(54) Method for manufacturing construction materials by using palm

(76) Inventors: Seong Hoon Han, Ansan-si (KR); Dae Hwan Kim, Ansan-si (KR)

Correspondence Address: ROBERT E. BUSHNELL & LAW FIRM, 2029 K STREET NW, SUITE 600, WASHINGTON, DC, 20006-1004, US

(21) Appl. No.: 12/005,360

(22) Filed: Dec. 27, 2007

(51) Int. Cl. B29C 70/42

(52) U.S. Cl. 264/115

(57) ABSTRACT

The construction materials are composed of biodegradable materials (palm fiber, powder of bamboo, etc) and mineral content (bioceramics, coal ash, etc), thus it can perform anti-fire function as well as antimicrobial, anti-mold and deodorization functions.

The construction materials are harmless to human because the palm fiber is used as a raw material. And further, highly strong construction materials can be provided because the palm fiber, which is crashed and cut in the size range of 1 cm to 1.5cm, are used with the palm fiber powder and thus the palm fiber acts as a bridge among other contents

The construction materials can perform antimicrobial, anti-mold and deodorization function because it includes the bamboo component and bioceramics.

### BACKGROUND OF THE INVENTION

1. Field of the Invention

The present invention relates to a method for manufacturing construction materials by using palm, more particularly, to a method for manufacturing a construction materials of biodegradable materials (palm fiber, powder of bamboo, etc) and mineral materials ( bioceramics, coal ash, etc). The construction materials according to is safe from the fire and it can block the generation of toxic gas. Further, antimicrobial, anti-mold and deodorization function can be realized.

In general, gypsum board, plywood or MDF (Medium Density Fiber) are used as construction materials of interior/exterior materials, cell-finishing materials of building,

However, this gypsum board has problems that it is easily-breaking and it can pollute human body or environment because gypsum dust is generated when it is broken.

Plywood and MDF have problems that they are very weak to humidity or water and especially they are so weak to fire that there is a big problem in safeness when fire starts. Thus, gypsum board, plywood and MDF are not adequate to use as construction materials.

Accordingly, non-inflammable paints are applied or a thin board of non-inflammable resin is added on the plywood or MDF in order to increase non-inflammability, but it is obvious that it has its limits because its raw materials are not non-inflammable.

Meanwhile various methods to overcome the defect of the gypsum board, for example to apply non-inflammable plywood on the gypsum board or to apply metal board as like steel board have been tried. However, this gypsum board is too heavy to use or to operate and its easily-breaking defect is remained as before.

That is, MDF or plywood are used generally in the present because they are easy to form, easy to operate, light and low-priced. However, there are problems that their water-resisting qualities are low, they are easy to burn because they do not have non-inflammabilities, semi-non-inflammability or fire retardant due to their inflammable raw materials and flame can spread rapidly when fire starts.

Gypsum board is made by the compound of chemical gypsum or plaster discharged from the fertilizer factory or power plant. It is excellent in manufacturing and operation, it is low-priced and it has non-inflammability, semi-non-inflammability and fire retardant.

However, there is problem to incur environmental pollution because it is very weal to humidity or water, it is easily-breaking due to its low strength, dust is generated when manufacturing, wasted gypsum cannot be reused, etc.

### SUMMARY OF THE INVENTION

An object of the present invention is to provide a method for manufacturing construction materials by using palm to add bioceramics powder and fly ash extracted from coal carbide to palm fiber and powder of pure vegetable property, by which environmental friendliness can be embossed and whose marketability can be increased.

Another object of the present invention is to provide a method for manufacturing construction materials by using palm capable of preventing the generation of troubles in the respiratory organs by toxic materials generated by for example, sick house syndrome and the generation of other allergies.

Still another object of the present invention is to provide a method for manufacturing construction materials which can be reused when wasted by rebuilding and by which dust does not generated. Thus no environmental pollution can be incurred.

Still another object of the present invention is to provide a method for manufacturing construction materials having non-inflammability, semi-non-inflammability and fire retardant.

The method for manufacturing construction materials according to the present invention includes the steps of;

drying a washed palm fiber until the dryness factor becomes 95%;

producing palm chips by crushing and cutting the dried palm fiber in the size range of 1 cm to 1.5 cm;

crashing the dried palm fiber into particles whose diameter is less than 200 meshes;

crushing bamboo into particles whose diameter is less than 200 meshes;

crushing bioceramics into particles whose diameter is less than 200 meshes;

producing raw materials by mixing the palm fiber chips, the palm fiber powder and the bamboo powder and the bioceramics powder in the proportion of 1:1:1:1;

producing a binder by mixing and melting an anti-fire agent and a fire retardant hardening resin of heat resisting resin in the proportion of 1:1;

mixing the binder 20˜30 WT % (percently weight), the mixed raw materials 50˜60 WT % and the fly ash 20˜25WT % to knead a dough in the semi-solid state;

burning the dough primarily by passing it through a forming element where 2 forming rollers heated in the temperature range of 150° C. to 200° C. are arranged at the regular space;

burning the primarily burned dough, a modeling compound, completely with forming it thinner and thinner by passing it through a rolling mill where a group of upper rollers and a group of lower rollers are arranged so that the space between them becomes narrower and narrower and heat of 150˜200° C. is applied;

cooling the modeling compound in the temperature range of 0° C. to 4° C. by passing it through a cooling element including a group of upper rollers and a group of lower rollers; and

cutting the modeling compound in the regular length by the blade, which elevates up and down by a cutting cylinder.

### DETAIL DESCRIPTION OF THE INVENTION

The present invention described above can be embodied in various ways and the preferred embodiment will be described in detail hereinafter.

Palm is the strongest in strength of vegetable materials and it is hard to burn. Palm fiber used in the present invention is sludge remained after oil is squeezed from palm fruit and it is mostly made by the fibroid material.

This fiber is washed cleanly and dried until a dryness factor becomes 95%. Part of palm fiber is crushed and cut in the size range of 1 cm to 1.5 cm. Remained are crushed into particles whose diameter is less than 200 meshes.

The bamboo is so porous that it is very effective in antimicrobial deodorization. The bamboo is crushed into particles whose diameter is less than 200 meshes as the palm is. Bioceramics is prepared for preventing lack of strength due to non-inflammability and for continuous far-infrared radiation. Bioceramics also crushed into particles whose diameter is less than 200 meshes.

The palm fiber chips, the palm fiber powder, the bamboo powder and the bioceramics powder are mixed in the proportion of 1:1:1:1 to produce raw materials.

The palm fiber chips are used to connect other components around firmly by its long strength, thus construction materials made after can be more durable and harder to broken. To increase dispersibility, the palm fiber powder and bamboo are crushed into particles whose diameter is less than 200 meshes.

To maintain smooth surface and strength, relatively light fly ash whose diameter is less than 200 meshes is extracted from the coal carbide.

To extract fly ash whose diameter is less than 200 meshes is to protect weight dispersion from being leaned to one side due to ash's light weight.

To increase fire retardant, the binder is produced by using the anti-fire agent and the fire retardant hardening resin of heat resisting resin.

To increase fire retardant and adhesion together, the anti-fire agent and the fire retardant hardening resin of heat resisting resin are mixed and melted in the proportion of 1:1.

After all the components are prepared, the binder 20˜30 WT % (percently weight), the mixed raw materials 50˜60 WT % and the fly ash 20˜25 WT % are mixed and kneaded to a dough in the semi-solid state.

By using the fly ash, density, surface/compressive strength can controlled according to the proportion. It is lighter than cement, but it is relatively heavy among the materials for fire retardant. Thus, although a problem in making products lighter can happen when its proportion is high, its fire retardant can be higher, relatively.

Thus, the proportion of the fly ash can be varied according to the property of each product. It is preferred that the proportion of the fly ash is equal to or less than 25 WT %.

If the proportion of the binder, which is made of the anti-fire agent and the fire retardant hardening resin of heat resisting resin, excesses more than 30 WT % with respect to the total weight, the strength of the construction materials after made may be lowered and if the proportion of the binder is less than 20 WT %, it may be hard to knead with other materials.

Further, to control strength, manufacturing non-inflammability, hardening agent such as Sodium Silicate, Calcium Silicate, etc or accelerator hardening can be used.

When the dough is passed through a forming element where 2 forming rollers heated in the temperature range of 150° C. to 200° C. are arranged at the regular space, it is burned from the surface with some amount of mobility.

When the primarily burned dough is passed through a rolling mill where a group of upper rollers and a group of lower rollers are arranged so that the space between them becomes narrower and narrower, it can be rolled thinner and thinner.

A heater capable of heating over the temperature range of 150° C. to 200° C. is provided in the group of the upper rollers and the group of the lower rollers in order that the modeling compound can be burned completely up to its interior completely as the modeling compound is rolled thinner and thinner.

If the modeling compound, which is burned and dried completely and which is formed to have adequate thickness, is passed through a cooling element including a group of upper rollers and a group of lower rollers in the temperature range of 0° C. to 4° C., it becomes adequately strong to use as construction materials.

Lastly, construction materials are manufactured completely by crashing cutting the modeling compound in the regular length by a blade which is elevated up and down by a cutting cylinder.

Because this manufactured construction materials are made by palm fiber, bamboo powder, bioceramics and fly ash, it is hard to make a white product. If a white inorganic colorant, which is strong against flame and which is good to conceal, is applied to make background color light ash color in order to make up this weak point, painting and coating of wood sheets on the manufactured products can be improved without troublesome.

As described above, the construction materials according to the present invention is harmless to human body because the palm fiber is used as a raw material. And further, highly strong construction materials can be provided because the palm fiber, which is crashed and cut in the size range of 1 cm to 1.5 cm, are used with the palm fiber powder and thus the palm fiber acts as a bridge among other contents

The construction materials according to the present invention can perform antimicrobial, anti-mold and deodorization function because it includes the bamboo component and bioceramics, thus mold, which cockroaches take, cannot be grown and the well-being trend to prefer odorless and far-infrared radiation/anion generation can be satisfied.

Because the palm fiber is a non-inflammable waste remained after palm oil production in the region of Indonesia, Malaysia, etc and it can be recycled according to the present, the cost can be lower.

Even if fire starts, flame and toxic gas are hardly generated. Thus, the construction materials according to the present invention are suitable for the building material. Further the construction materials according to the present invention are easy to form and its strength and water-resisting qualities are good. Because the construction materials according to the present invention are non-inflammable, it can be used as a lumber or gypsum board and it is effective as an environment-friendly construction materials. Because the construction materials according to the present invention can be produced continuously, productivity can be increased and also the cost of equipment can be reduced.

What is claimed is:

1. A method for manufacturing construction materials by using palm, comprising the steps of;
drying a washed palm fiber until the dryness factor becomes 95%;
producing palm chips by crashing and cutting the dried palm fiber in the size range of 1 cm to 1.5 cm;
crashing the dried palm fiber into particles whose diameter is less than 200 meshes;
crushing bamboo into particles whose diameter is less than 200 meshes;
crushing bio-ceramics into particles whose diameter is less than 200 meshes;
producing raw materials by mixing the palm fiber chips, the palm fiber powder and the bamboo powder and the bioceramics powder in the proportion of 1:1:1:1;
extracting fly-ash whose diameter is less than 200 meshes from coal carbide;
producing a binder by mixing and melting an anti-fire agent and a fire retardant hardening resin of heat resisting resin in the proportion of 1:1;
mixing the binder 20˜30 WT % (percently weight), the mixed raw materials 50˜60 WT % and the fly ash 20˜25 WT % to knead a dough in the semi-solid state;
burning the dough primarily by passing it through a forming element where 2 forming rollers heated in the temperature range of 150° C. to 200° C. are arranged at the regular space;
burning the primarily burned dough, a modeling compound, completely with forming it thinner and thinner by passing it through a rolling mill where a group of upper rollers and a group of lower rollers are arranged so that the space between them becomes narrower and narrower and heat of 150˜200° C. is applied;
cooling the modeling compound in the temperature range of 0° C. to 4° C. by passing it through a cooling element including a group of upper rollers and a group of lower rollers; and
cutting the modeling compound in the regular length by the blade which is elevated up and down by a cutting cylinder.
